(19) United States
(12) Patent Application Publication
(10) Pub. No.: US 2026/0099612 A1
(43) Pub. Date: Apr. 9, 2026

(54) DIGITAL DOCUMENT WITH ENHANCED SECURITY AND TRACKING

(71) Applicant: Bank of America Corporation, Charlotte, NC (US)

(72) Inventors: Manu Kurian, Dallas, TX (US); Harinath Meedinti Bhaskara Reddy, Charlotte, NC (US); Sasikumar Purushothaman, Frisco, TX (US)

(21) Appl. No.: 18/908,935

(22) Filed: Oct. 8, 2024

(51) Int. Cl. G06F 21/60

(52) U.S. Cl. CPC G06F 21/602

(57) ABSTRACT

Systems and methods for generating digital documents with embedded security features are provided. Methods may include receiving a first dataset comprising content data that was manually inputted by a system user, receiving a second dataset comprising an identifier associated with the system user, receiving a third dataset comprising a location associated with the system user, and cryptographically embedding, via a machine-learning (ML) module, the second and the third datasets into the first dataset to create a fourth dataset. In the fourth dataset, the first dataset may be visible to a human viewer while the second and the third datasets are invisible, and the second and third datasets may be extractable by a trusted system in possession of a cryptographic key. Methods may include generating an output document displaying the fourth dataset.

### FIELD OF TECHNOLOGY

Aspects of the disclosure relate to digital systems. Specifically, aspects of the disclosure relate to digital documents with embedded security features.

### BACKGROUND OF THE DISCLOSURE

The proliferation of digital documents has revolutionized the way information is created, shared, and stored across various industries. From legal contracts and financial records to confidential business communications, digital documents have become a cornerstone of modern business practices.

However, with this widespread adoption comes a growing need for enhanced security measures to ensure that sensitive information remains protected throughout its lifecycle. Furthermore, digital documents are frequently shared across multiple platforms, devices, and geographical locations, making it challenging to track their usage and maintain oversight once they leave the originating party's control.

It would be desirable, therefore, to provide systems and methods for embedding security and tracking features into digital documents, providing enhanced control and protection to meet the growing security demands of the digital age.

### SUMMARY OF THE DISCLOSURE

Aspects of the disclosure relate to machine-learning (ML)-based systems for generating digital documents with embedded security features.

Systems may be configured to receive a first dataset comprising content data that was manually inputted by a system user, receive a second dataset comprising an identifier associated with the system user, and receive a third dataset comprising a location associated with the system user.

Systems may be configured, via an ML module, to cryptographically embed the second and third datasets into the first dataset to create a fourth dataset. The fourth dataset may be configured such that the first dataset may be visible to a human viewer of the fourth dataset and the second and third datasets may be invisible to the human viewer of the fourth dataset. The second and third datasets may be extractable by a trusted system in possession of a cryptographic key. The systems may also be configured to generate an output document displaying the fourth dataset.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative apparatus in accordance with principles of the disclosure;

FIG. 3 shows an illustrative flowchart in accordance with principles of the disclosure;

FIG. 4 shows an illustrative diagram in accordance with principles of the disclosure; and

FIG. 5 shows another illustrative diagram in accordance with principles of the disclosure.

### DETAILED DESCRIPTION OF THE DISCLOSURE

Systems and methods for generating digital documents with embedded security features are provided. System features and configurations may, in certain embodiments, correspond to steps of the methods. Systems may include a processor, a machine-learning (ML) module, a non-transitory memory, and computer executable instructions stored in the memory, that, when run on the processor, are configured to provide system features and/or execute method steps.

Systems may be configured to receive a first dataset comprising content data that was manually inputted by a system user. Content data may include any suitable data inputted by a user for inclusion in a document. For example, content data may include alphanumeric text, symbols, and/or images inputted via a keyboard, touch screen, audio feed, or any other suitable input method. The content data may be for the body of a document. Content data may include a signature. The document may, for example, be a legal document such as a contract or agreement. The document may be a literary document, artistic work, or identification document. The document may represent or be associated with a financial instrument such as a credit or debit card.

Systems may be configured to receive a second dataset comprising an identifier associated with the system user. In certain embodiments, the identifier may be a name, social security number, alphanumeric code, customer/client number, and/or any other suitable identifier associated with the system user (including, in certain embodiments, an identifier of a device associated with the user, such as a serial number of a device used for the inputting).

Systems may be configured to receive a third dataset comprising a location associated with the system user. In some embodiments, the location may be a location of residence, employment, or operation of the system user. The location may alternatively or additionally include a location where the system user inputted the content data of the first dataset. The location may, in certain embodiments, include a digital location of the user or associated device, such as an email address or IP address.

Systems may be configured, via an ML module, to cryptographically embed the second and/or the third datasets (i.e., identifier and location data) into the first dataset (i.e., content data) to create a fourth dataset, also referred to herein as an augmented dataset.

The cryptographic embedding may include processes known in the art as “steganography”, and/or any other suitable cryptographic method of embedding information among display content in a way that is invisible to a viewer. For example, the embedding may include concealing information within a preset number of the lowest bits of noisy images or files, using non-printing Unicode characters (e.g., Zero-Width Joiner (ZWJ) or Zero-Width Non-Joiner (ZWNJ)), or any other suitable embedding approach.

This embedding may result in a “polymorphic” dataset in which one set of symbols may convey multiple different types of messages, some in the visible realm and others in an invisible one, as described further below.

The fourth dataset may be configured such that the first dataset (the content data) may be visible to a human viewer of the fourth dataset and the second and the third datasets (the identifier and location) may be invisible to the human viewer of the fourth dataset. The second and third datasets may be extractable by a trusted system in possession of a cryptographic key. The cryptographic key may, for example, reverse the cryptographic embedding process to reveal the hidden information. For example, if the hidden information is embedded in the least two significant bits of the color components of a file, the cryptographic key may include removing all but those two least significant bits of all the color components of the file. The systems may also be configured to generate an output document displaying the fourth dataset.

In certain embodiments, the system user may be a first user and the system may be further configured to receive a fifth dataset comprising content data that was manually inputted by a second system user. The system may also be configured to receive a sixth dataset comprising an identifier associated with the second system user, and to receive a seventh dataset comprising a location associated with the second system user.

The system may be further configured to cryptographically embed, via the ML module, the sixth and the seventh datasets into the fifth dataset to create an eighth dataset. The embedding may be performed such that the fifth dataset is visible to a human viewer of the eighth dataset, while the sixth and the seventh datasets are invisible to the human viewer of the eighth dataset. The sixth and seventh datasets may be extractable by the trusted system in possession of the cryptographic key.

The system may, when generating the output document, configure the output document to display the eighth dataset in combination with the fourth dataset. The fourth and eighth datasets may individually or in combination be referred to as an augmented dataset. The content data of the first and second users may, for example, be visible in separate portions of the augmented dataset, while the invisible information (e.g., location and identifier of both users) may be embedded across both portions of the augmented dataset. In some embodiments, the fourth and the eighth datasets may be segmented in the output document, and the invisible information (e.g., location and identifier) of each user may be embedded separately, with the invisible information of each user embedded in the portion displaying the content data of that respective user.

The system may, in some embodiments, be extendable to any suitable number of system users, and each user's respective content data inputs along with their unique identifiers, locations, etc.

In certain embodiments, the system may further comprise a location safety module. The system may be further configured, in response to a predetermined type of access of the output document, to submit a request to the location safety module. The access may include opening the document. The access may include attempting to edit or otherwise change the document, or a sensitive portion (e.g., a signature, date, etc.) thereof.

The request may include the third dataset (i.e., location information associated with the system user) and a current location of the output document. When a relationship between the location of the third dataset and a current location of the output document satisfies a predetermined condition, the system may be configured to execute a predetermined action.

The predetermined condition may, for example, include the current location being outside (or, in some embodiments, inside) of a predetermined perimeter about the location of the third dataset. The perimeter may, for example, define a predetermined area (e.g., a square mile) around the location, a number of city blocks around the location, a zip code of the location, a city, county, state, or country of the location, or any other suitable perimeter around the location.

The predetermined action may, for example, be designed to prevent usage of the output document. The predetermined action may, in some embodiments, include cryptographically locking the output document such that the first dataset is invisible to a human viewer of the output document absent a second cryptographic key (which may, in some embodiments, be interchangeable with the first cryptographic key). The predetermined action may include locking the output document to disallow any content edits. The predetermined action may include transmitting a signal to a device that is accessing the output document, and the signal may include conveying that the output document is non-operational. The predetermined action may, in certain embodiments, include rendering an associated payment instrument frozen or otherwise non-operational.

In some embodiments, the system may be further configured to segment the first dataset into a series of portions based on a time of input. Via the ML module, the system may be configured to cryptographically embed timestamp information into each portion as part of the fourth dataset. This feature may provide an effective way to track edits and versions in the document across users and devices.

In certain embodiments, the system may be further configured to toggle the second and/or third datasets to a visible state in response to receiving an alert that the output document is in a misplaced state. The alert may, for example, be triggered with a predetermined condition as described above, such as when the system ascertains that a current location of the document is outside of a predetermined perimeter about the location of the third dataset. In some embodiments, the alert may be initiated by the system user via a digital device connected to the system. A “return to owner” feature is thus provided, which may include conveying information from the second or third datasets (e.g., a location or email address of the system user) to a device accessing the output document, thereby enabling a return of the digital document to its appropriate owner.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

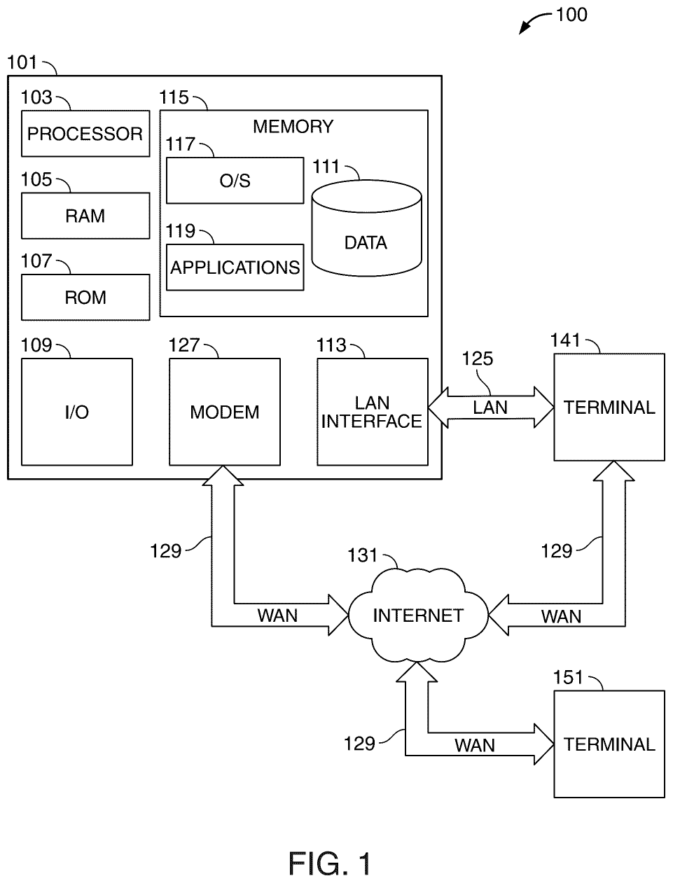

FIG. 1 shows an illustrative block diagram of system 100 that includes computer 101. Computer 101 may alternatively be referred to herein as a “server” or a “computing device.” Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may comprise any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to generating digital documents with embedded security and tracking features. The input/output module may also include one or more speakers for providing audio output and a video display device for providing textual, audio, audiovisual, and/or graphical output. The input and output may be related to computer application functionality. The input and output may be related to generating digital documents with embedded security and tracking features.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related to performing various tasks. The various tasks may be related to generating digital documents with embedded security and tracking features.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry TM, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

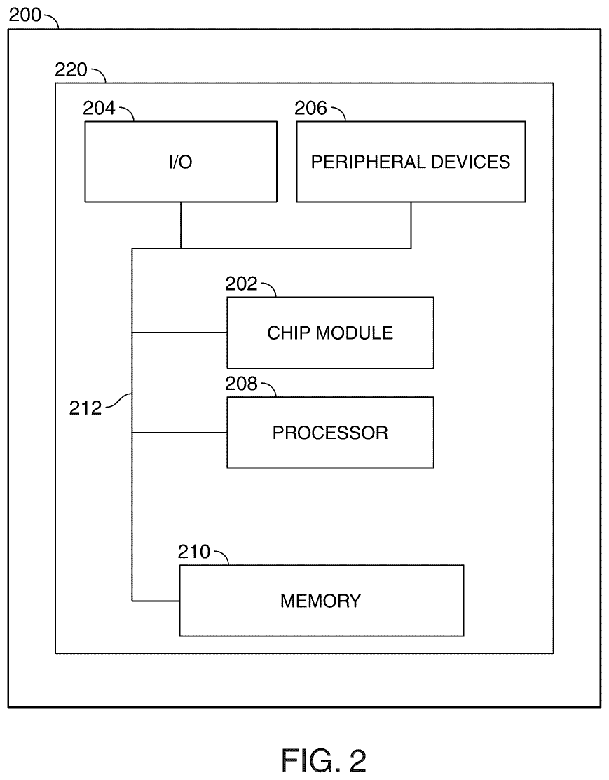

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

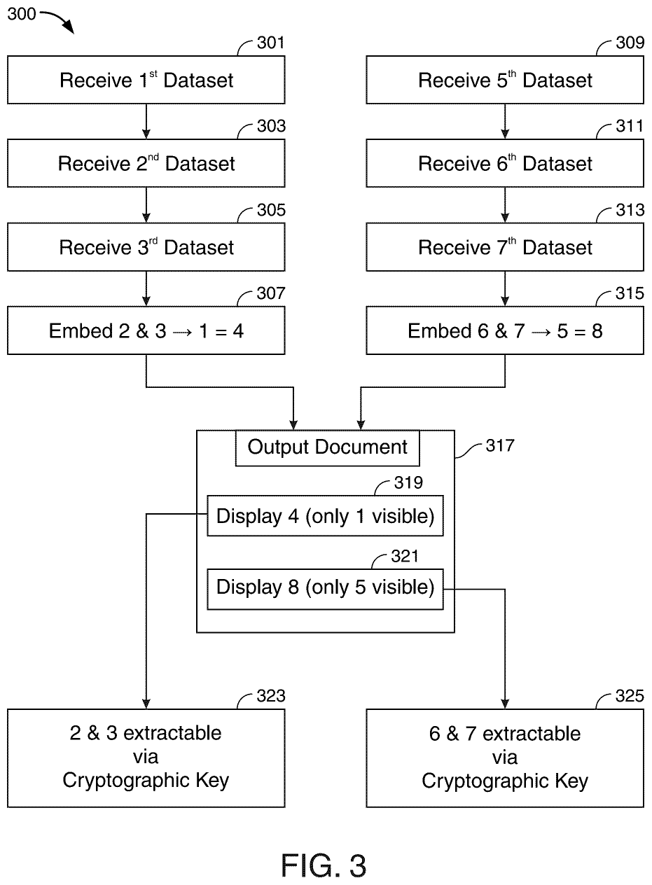

FIG. 3 shows illustrative flowchart 300 in accordance with principles of the disclosure. At step 301, a first dataset (including content data that was manually inputted by a first system user) is received. At step 303, a second dataset (including an identifier associated with the first system user) is received. At step 305, a third dataset (including a location associated with the first system user) is received.

At step 307, the second and third datasets may be embedded into the first dataset to create a fourth dataset. The fourth dataset may be configured such that the first dataset may be visible to a human viewer of the fourth dataset and the second and third datasets may be invisible to the human viewer of the fourth dataset. Moreover, the second and third datasets may be extractable by a trusted system in possession of a cryptographic key.

At step 309, a fifth dataset (including content data that was manually inputted by a second system user) is received. At step 311, a sixth dataset (including an identifier associated with the second system user) is received. At step 313, a seventh dataset (including a location associated with the second system user) is received.

At step 315, the sixth and seventh datasets may be embedded into the fifth dataset to create an eighth dataset. The eighth dataset may be configured such that the fifth dataset may be visible to a human viewer of the eighth dataset and the sixth and seventh datasets may be invisible to the human viewer of the eighth dataset. Moreover, the sixth and seventh datasets may be extractable by a trusted system in possession of a cryptographic key.

At step 317, an output document may be generated. The output document may display an augmented dataset including the fourth (at 319) and eighth (at 321) datasets, of which only the first and fifth datasets may be visible. However, the second and third datasets (step 323) and the sixth and seventh datasets (step 325) may be extractable from the output document via a cryptographic key.

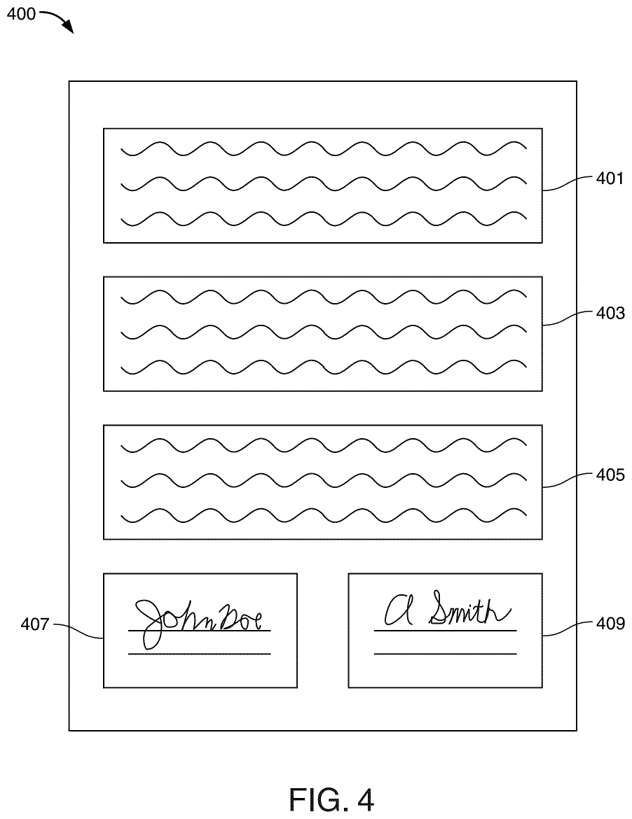

FIG. 4 shows illustrative diagram 400 in accordance with principles of the disclosure. Diagram 400 represents an embodiment of an output document with embedded security and tracking features. The output document may include first portion 401. First portion 401 may include text inputted by a first user at a first time. First portion 401 may display the text visibly while embedding identification, time, location, and/or version information in a cryptographic way that is invisible to a human viewer of the output document.

The output document may include second portion 403. Second portion 403 may include text inputted by the first user at a second time. Second portion 403 may display the text visibly while embedding identification, time, location, and/or version information in a cryptographic way that is invisible to a human viewer of the output document, thereby providing invisible version tracking for the document.

The output document may include third portion 405. Third portion 405 may include text inputted by a second user at a third time. Third portion 405 may display the text visibly while embedding identification, time, location, and/or version information in a cryptographic way that is invisible to a human viewer of the output document, thereby providing invisible authorship tracking for the document.

The output document may include any additional number of portions, which may, in certain embodiments, include signature content, as shown in portions 407 and 409. Such signature content may be considered sensitive portions, and attempted edits to such sensitive portions may trigger location safety module features, as described above.

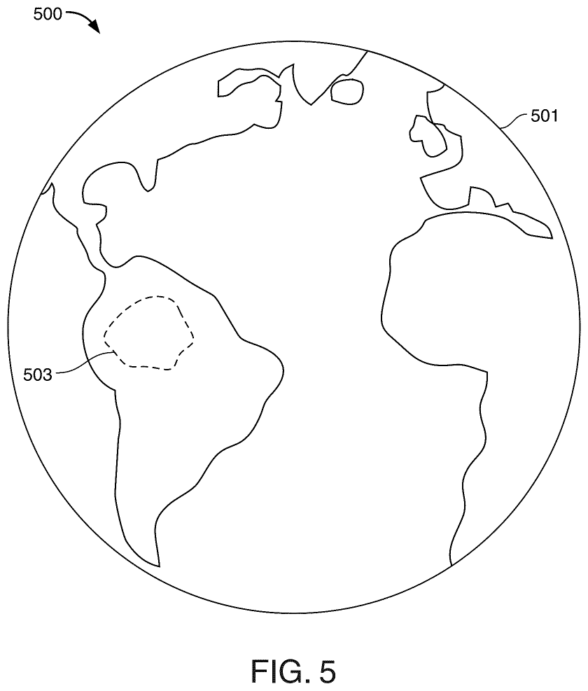

FIG. 5 shows illustrative diagram 500 in accordance with principles of the disclosure. Diagram 500 shows map 501 including location perimeter 503. Location perimeter 503 may, for example, define a predetermined area (e.g., a square mile) around a location embedded in the output document, a number of city blocks around the location, a zip code of the location, a city, county, state, or country of the location, or any other suitable perimeter around the location. When the system determines that a predetermined relationship between the current location of the output document and location perimeter 503 is satisfied, the system may be configured to execute a predetermined action, which may, for example, be designed to prevent usage of the output document.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for digital documents with enhanced security and tracking are provided. Persons skilled in the art will appreciate that the present invention can be practiced by other than the described embodiments, which are presented for purposes of illustration rather than of limitation, and that the present invention is limited only by the claims that follow.

What is claimed is:

1. A machine-learning (ML)-based system for generating digital documents with embedded security features, the system comprising:
a processor;
an ML module;
a non-transitory memory; and
computer executable instructions stored in the memory, that, when run on the processor, are configured to:
receive a first dataset comprising content data that was manually inputted by a system user;
receive a second dataset comprising an identifier associated with the system user;
receive a third dataset comprising a location associated with the system user;
via the ML module, cryptographically embed the second and the third datasets into the first dataset to create a fourth dataset, such that:
the first dataset is visible to a human viewer of the fourth dataset;
the second and the third datasets are invisible to the human viewer of the fourth dataset; and
the second and third datasets are extractable by a trusted system in possession of a cryptographic key; and
generate an output document displaying the fourth dataset.

2. The system of claim 1 wherein the system user is a first user and the system is further configured to:
receive a fifth dataset comprising content data that was manually inputted by a second system user;
receive a sixth dataset comprising an identifier associated with the second system user;
receive a seventh dataset comprising a location associated with the second system user;
via the ML module, cryptographically embed the sixth and the seventh datasets into the fifth dataset to create an eighth dataset, such that:
the fifth dataset is visible to a human viewer of the eighth dataset;
the sixth and the seventh datasets are invisible to the human viewer of the eighth dataset; and
the sixth and seventh datasets are extractable by the trusted system in possession of the cryptographic key; and
generate the output document displaying the eighth dataset in combination with the fourth dataset.

3. The system of claim 2 wherein the fourth and the eighth datasets are segmented in the output document.

4. The system of claim 1 further comprising a location safety module, and the system is further configured, in response to a predetermined type of access of the output document, to:
submit a request to the location safety module, said request comprising the third dataset and a current location of the output document; and
when a relationship between the third dataset and a current location of the output document satisfies a predetermined condition, execute a predetermined action to prevent usage of the output document.

5. The system of claim 4 wherein the predetermined action comprises:
cryptographically locking the output document such that the first dataset is invisible to a human viewer of the output document absent a second cryptographic key;
locking the output document to disallow any content edits; or
transmitting a signal to a device that is accessing the output document, said signal conveying that the output document is non-operational.

6. The system of claim 1 further configured to:
segment the first dataset into a series of portions based on a time of input; and
via the ML module, cryptographically embed timestamp information into each portion as part of the fourth dataset.

7. The system of claim 1 further configured to toggle the second and third datasets to a visible state in response to receiving an alert that the output document is in a misplaced state.

8. The system of claim 1 wherein the location is a location of residence of the system user and/or a location where the system user inputted the content data of the first dataset.

9. The system of claim 1 wherein the identifier is a name, social security number, and/or alphanumeric code associated with the system user.

10. A method for generating digital documents with embedded security features, the system comprising:
receiving a first dataset comprising content data that was manually inputted by a system user;
receiving a second dataset comprising an identifier associated with the system user;
receiving a third dataset comprising a location associated with the system user;
cryptographically embedding, via a machine-learning (ML) module, the second and the third datasets into the first dataset to create a fourth dataset, such that:
the first dataset is visible to a human viewer of the fourth dataset;
the second and the third datasets are invisible to the human viewer of the fourth dataset; and
the second and third datasets are extractable by a trusted system in possession of a cryptographic key; and
generating an output document displaying the fourth dataset.

11. The method of claim 10 wherein the system user is a first user and the method further comprises:
receiving a fifth dataset comprising content data that was manually inputted by a second system user;
receiving a sixth dataset comprising an identifier associated with the second system user;
receiving a seventh dataset comprising a location associated with the second system user;
via the ML module, cryptographically embedding the sixth and the seventh datasets into the fifth dataset to create an eighth dataset, such that:
the fifth dataset is visible to a human viewer of the eighth dataset;
the sixth and the seventh datasets are invisible to the human viewer of the eighth dataset; and
the sixth and seventh datasets are extractable by the trusted system in possession of the cryptographic key; and
generating the output document displaying the eighth dataset in combination with the fourth dataset.

12. The method of claim 11 wherein the fourth and the eighth datasets are segmented in the output document.

13. The method of claim 10 further comprising, in response to a predetermined type of access of the output document:
submitting a request to a location safety module, said request comprising the third dataset and a current location of the output document; and
when a relationship between the third dataset and a current location of the output document satisfies a predetermined condition, executing a predetermined action to prevent usage of the output document.

14. The method of claim 13 wherein the predetermined action comprises:
cryptographically locking the output document such that the first dataset is invisible to a human viewer of the output document absent a second cryptographic key;
locking the output document to disallow any content edits; or
transmitting a signal to a device that is accessing the output document, said signal conveying that the output document is non-operational.

15. The method of claim 10 further comprising:
segmenting the first dataset into a series of portions based on a time of input; and
via the ML module, cryptographically embedding timestamp information into each portion as part of the fourth dataset.

16. The method of claim 10 further comprising toggling the second and third datasets to a visible state in response to receiving an alert that the output document is in a misplaced state.

17. The method of claim 10 wherein the location is a location of residence of the system user and/or a location where the system user inputted the content data of the first dataset.

18. The method of claim 10 wherein the identifier is a name, social security number, and/or alphanumeric code associated with the system user.

19. A machine-learning (ML)-based system for generating digital documents with embedded security features, the system comprising:
a processor;
an ML module;
a non-transitory memory; and
computer executable instructions stored in the memory, that, when run on the processor, are configured to:
receive content data that was manually inputted by a system user;
receive an identifier associated with the system user;
receive a location associated with the system user;
via the ML module, cryptographically embed the identifier and the location into the content data to create an augmented dataset, such that:
the content data is visible to a human viewer of the augmented dataset;
the identifier and the location are invisible to the human viewer of the augmented dataset; and
the identifier and the location are extractable by a trusted system in possession of a cryptographic key; and
generate an output document displaying the augmented dataset.

20. The system of claim 19 wherein:
the system is further configured to:
receive content data that was manually inputted by a second system user;
receive an identifier associated with the second system user;
receive a location associated with the second system user;
via the ML module, cryptographically embed the identifier and the location of the second system user with the content data of the second system user into the augmented dataset, such that:
the content data of the second system user is visible to the human viewer of the augmented dataset;
the identifier and the location of the second system user are invisible to the human viewer of the augmented dataset; and
the identifier and the location of the second system user are extractable by the trusted system in possession of the cryptographic key; and
generate the output document displaying the augmented dataset inclusive of the content data, the identifier and the location of the first system user and the content data, the identifier and the location of the second system user; and
the system is further configured to:
segment the content data of both system users into a series of portions based on a time of input; and
via the ML module, cryptographically embed timestamp information into each portion as part of the augmented dataset.
